(19) United States
(12) Patent Application Publication
(10) Pub. No.: US 2008/0109316 A1
(43) Pub. Date: May 8, 2008

(54) POINTER REGION CAPTURE TO FORM A REGISTRY INDEPENDENT OF A MERCHANT SITE

(76) Inventor: Rahul Pandhe, Fremont, CA (US)

Correspondence Address: Raj Abhyanker LLP;c/o Intellevate, P.O.Box 52050, Minneapolis, MN, 55402, US

(21) Appl. No.: 11/972,078

(22) Filed: Jan. 10, 2008

Related U.S. Application Data
(63) Continuation-in-part of application No. 10/709,888, filed on Jun. 3, 2004.
(63) Continuation-in-part of application No. 11/037,861, filed on Jan. 18, 2005.

(51) Int. Cl. G06Q 30/00

(52) U.S. Cl. 705/14; 705/26

(57) ABSTRACT

A method, apparatus and system of method and system of pointer region capture to form a registry independent of a merchant site is disclosed. In one embodiment, a method a registry module, includes determining an item boundary surrounding a current location of a pointer based on a merchant site mapping table and a markup language characteristic of the merchant site, extracting an item information from within the item boundary and communicating the item information to a registry of a central database. In addition, the method may further include determining that a link to a details data associated with an item defined through the item information is adjacent to the pointer in an area defined by the item boundary, automatically extracting the details data from the link and communicating the details data by and the item information to the registry of the central database.

### CLAIMS OF PRIORITY

This application is a continuation in part and claims priority from:

(1) U.S. Provisional patent application No. 60/485,231 filed on Jul. 7, 2003.

(2) U.S. Utility patent application number 10/709,888 filed on Jun. 3, 2004.

(3) U.S. Utility patent application number 11/037,861 filed on Jan. 18, 2005.

### FIELD OF TECHNOLOGY

This disclosure relates generally to the technical fields of software and database technology and, in one example embodiment, to a method and system of pointer region capture to form a registry independent of a merchant site.

### BACKGROUND

A user (e.g., an individual, a group, etc.) may form a registry (e.g., a collection of desired items being marketed) on a website (e.g., Amazon.com®, Macys.com®, etc.) of a merchant. The user may wish for others to purchase items placed in the registry (e.g., a wedding registry, a graduation registry, etc.) on behalf of the user. The merchant may need to make a significant investment in making the registry available though the website (e.g., in information technology, engineering, and/or support resources). For example, the merchant may need to contract with a third party registry provider and/or hire programmers to write and maintain the registry on the website of the merchant. The merchant may find it cost prohibitive to create and maintain the registry on the website.

As an alternative, the individual may choose to create the registry on an independent website. However, the individual may need to manually enter information on the independent website for each item. This may be a difficult and/or error prone task because the individual may leave out information needed to identify an item being marketed. As such, the individual may not be able to create the registry on either the website of the merchant or on the independent website. As a result, the merchant may lose significant revenue opportunity. Furthermore, the individual may not be able to acquire the items they desire from the merchant.

### SUMMARY

A method and system of pointer region capture to form a registry independent of a merchant site is disclosed. In one aspect, a method of a registry module (e.g., a client-side application that works across different ones of the merchant site) includes determining an item boundary surrounding a current location of a pointer based on a merchant site mapping table and a markup language characteristic of the merchant site (e.g., no modification is required to the merchant site), extracting an item information from within the item boundary and communicating the item information to a registry of a central database.

The method may further include automatically determining a price, a description, a picture and/or an offer period through the item information. In addition, the method may further include determining that a link to a detail data associated with an item defined through the item information is adjacent to the pointer in an area defined by the item boundary, automatically extracting the details data from the link and communicating the details data and the item information to the registry of the central database. The method may further include creating a bookmark of a page associated with the link and associating the bookmark with the registry such that the details data is accessible through the bookmark embedded in the registry.

The method may further include processing a donation provided by a patron of a user associated with the item information and applying the donation toward consideration required to transact the item associated with the item information. The method may further include enabling the user to redeem the cash donation when the cash donation does not meet the consideration required to transact the item associated with the item information.

In addition, the method may further include applying a manual update data generated through a separate window having extracted item information and communicating the manual update data to the registry of the central database. The method may further include referencing a coupon module having any number of coupon data with the extracted item information and the manual update data and placing a coupon in an area adjacent to the item information in the registry. The method may further include periodically updating the merchant site mapping table to deliver more relevant results by heuristically adapting the item boundary of a specific merchant site by observing an error log and manual override patterns of the user of the registry module (e.g., may be embedded as an indicator in a browser).

The method may further include applying a time marker to the item information (e.g., where a user activates the extracting of the item information when the user drags and drops the pointer to the indicator) in the registry such that the time marker indicates how long an item associated with the item information adheres to a set of terms associated with the item. In addition, the method may further include embedding the registry module in a widget that can be placed across any number of social media environments.

In another aspect, a system includes any number of ecommerce portals each offering a set of items being marketed to consumers through a network, client devices having a registry module to place set of items in a registry associated with a user and a central server having a central database to store data captured by the client devices through the registry module, and to optimize accuracy of capture of the registry modules by monitoring behaviors of the user rectifying issues in individual ones of the set of items represented in the registry.

In addition, the system may further include an error correction module of the central server to apply a set of algorithms to optimize performance of the registry module and to periodically provide updates to the registry module such that the periodic updates refresh an item information of the registry module. The system may further include an area locator module to capture an area adjacent to a pointer associated with the user in each of the client devices, and to automatically determine an item information associated each item in the registry.

In yet another aspect, a method includes accessing a central server to determine a set of boundaries associated with an area adjacent to pointer on an external commerce page, capturing a set of product information from the determined set of boundaries, modifying the captured product information based on a user request, placing the captured product information in a registry of the central server and processing a consideration toward acquisition of an item associated with the product information provided by a third party to the user through the registry.

The payment may be a partial payment applicable to an aggregate payment required to purchase an item associated with the product information for the user. The method may further include periodically refreshing a set of rules associated with the external commerce page by observing a behavior pattern of the user in modifying the captured product information in relation to locations of the external commerce page. In addition, the method may include automatically converting a standard link to the captured product information to a commissionable link offered by a merchant affiliate program. The method may inform a merchant of the merchant affiliate program when the set of product information is modified in the registry and when the consideration toward acquisition is provided by the third party to the user.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of registry modules at client devices and a central server communicating with any number of merchant device(s), according to one embodiment.

FIG. 2 is an exploded view of the central server, according to one embodiment.

FIG. 3 is a table view of details of item information associated with the registry of the user, according to one embodiment.

FIG. 4 is a flow chart of installing an “add gift” tool link in the browser by process of creating an account and setting up the registry in third party ecommerce site, according to one embodiment.

FIG. 5 is a continuation of the flow chart of FIG. 4 illustrating additional processes when the “add gift” tool link is not installed, according to one embodiment.

FIG. 6 is a continuation of the flow chart of FIG. 4 illustrating additional processes for creating a gift registry, according to one embodiment.

FIG. 7 is a flow chart for contributing gifts through various features, according to one embodiment.

FIG. 8 is a continuation of the flow chart of FIG. 7 illustrating additional processes of creating private cash pools, according to one embodiment.

FIG. 9 is a procedure view of giving and receiving gifts through an online shopping process, according to one embodiment.

FIG. 10 is a user interface view of a merchant site, according to one embodiment.

FIG. 11 is a user interface view of a sample registry, according to one embodiment.

FIG. 12A is a process flow of extracting the details data from a link, according to one embodiment.

FIG. 12B is a continuation of the process flow of FIG. 12A illustrating additional processes, according to one embodiment.

FIG. 12C is a continuation of the process flow of FIG. 12B illustrating additional processes, according to one embodiment.

FIG. 13A is a process flow of capturing and placing product information in a registry, according to one embodiment.

FIG. 13B is a continuation of the process flow of FIG. 13A illustrating additional processes, according to one embodiment.

Other features of the present embodiments will be apparent from the accompanying drawings and from the detailed description that follows.

### DETAILED DESCRIPTION

A method and system of pointer region capture to form a registry independent of a merchant site is disclosed. In the following description, for the purposes of explanation, numerous specific details are set forth in order to provide a thorough understanding of the various embodiments. It will be evident, however to one skilled in the art that the various embodiments may be practiced without these specific details.

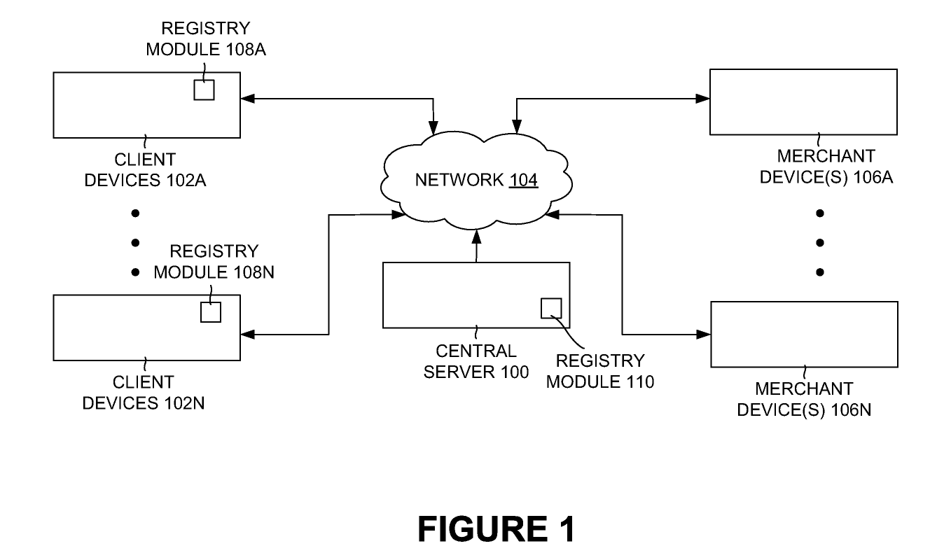

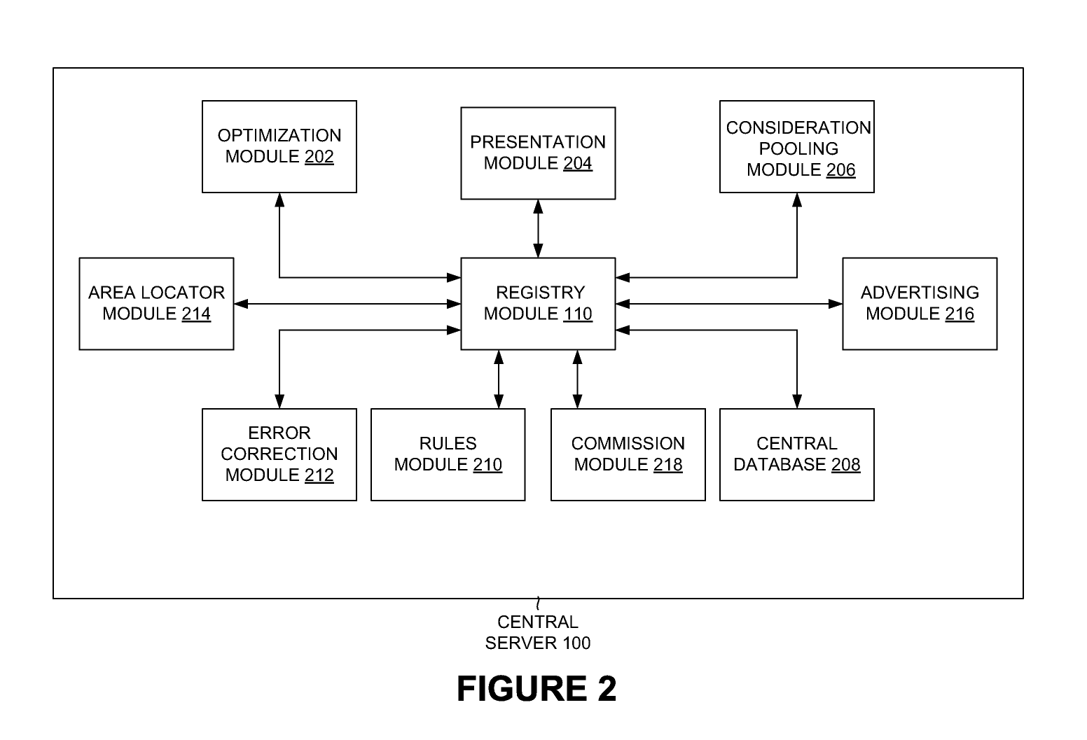

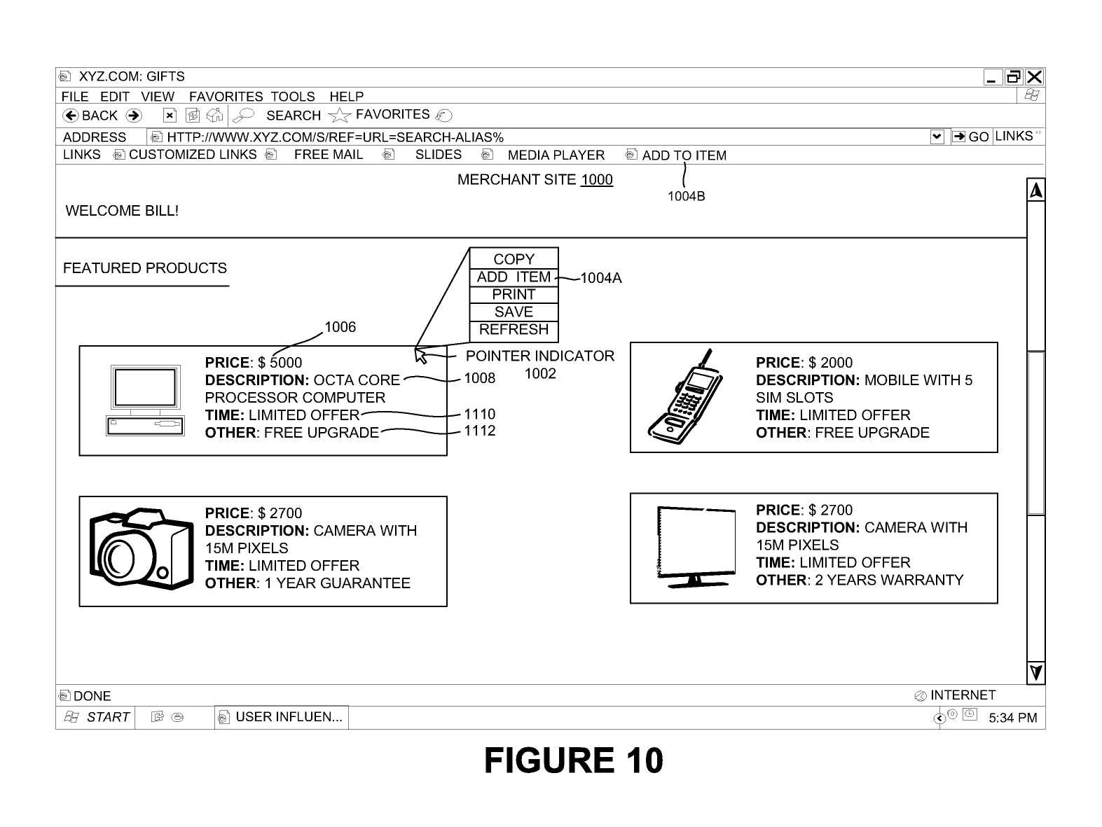

In one embodiment, a method of a registry module (e.g., the registry module 108A-N of FIG. 1) includes determining an item boundary surrounding a current location of a pointer (e.g., the pointer indicator 1002 of FIG. 10) based on a merchant site (e.g., the merchant site 1000 of FIG. 10) mapping table and a markup language characteristic of the merchant site 1000, extracting an item information from within the item boundary (e.g., as illustrated in FIG. 10) and communicating the item information to a registry of a central database (e.g., the central database 208 of FIG. 2).

In another embodiment, a system includes ecommerce portals each offering a set of items being marketed to consumers through a network (e.g., the network 104 of FIG. 1), client devices (e.g., the client devices 102A-N of FIG. 1) having registry modules 108A-N to place certain ones of the set of items in a registry associated with a user and a central server 100 having a central database 208 to store data captured by the client devices 102A-N through the registry modules 108A-N, and to optimize accuracy of capture of the registry modules 108A-N by monitoring behaviors of the user rectifying issues in individual ones of the set of items represented in the registry.

In yet another embodiment, a method includes accessing a central server 100 to determine a set of boundaries associated with an area adjacent to pointer (e.g., the pointer indicator 1002 of FIG. 2) on an external ecommerce page, capturing a set of product information from the determined set of boundaries (e.g., as illustrated in FIG. 10), modifying the captured product information based on a user request, placing the captured product information in a registry of the central server 100 and processing a consideration toward acquisition of an item associated with the product information provided by a third party to the user through the registry.

FIG. 1 is a system view of registry modules (e.g., the registry modules 108A-N and the registry module 110 of FIG. 1) at client devices 102A-N and a central server 100 communicating with any number of merchant device(s) 106A-N, according to one embodiment. Particularly, FIG. 1 illustrates the central server 100, the client devices 102A-N, a network 104, the merchant device(s) 106A-N, the registry modules 108A-N and the registry module 110, according to one embodiment.

The central server 100 may include a central database (e.g., the central database 208 of FIG. 2) to store data captured by the client devices 102A-N through the registry modules 108A-N, and to optimize accuracy of capture of the registry modules 108A-N by monitoring behaviors of the user rectifying issues in individual ones of the set of items represented in the registry. For example, the registered user can setup his/her registry (e.g., shopping list, wish list, gift registry, wedding registry, etc.) as a personal catalog with gifts pulled up from any website on the entire internet.

The products (e.g., items, gifts, etc) selected by the user may be managed and maintained by the central server 100 so that other users (e.g., patrons, friends, fans, family members, co-workers observers, etc.) can collectively contribute gifts to the user. The client devices 102A-N may have the registry modules 108A-N to place certain ones of the set of items in the registry associated with the user.

The network 104 (e.g., Internet, wireless Internet, WAN, LAN, Bluetooth, Wi-Fi, Wi-Max, telecommunications, radio frequency and/or infrared network, etc.) may enable communication between the client devices 102A-N and the merchant device(s) 106A-N through the central server 100. The merchant device(s) 106A-N may market various products featured on a website of the merchant. The website may display deals which motivates a user to purchase an item from the registry. The registry modules 108A-N may be included in the client devices 102A-N which is connected to the user with an internet (e.g., through a personal computer). The registry module 110 may be included in the central server 100 to store individual set of items represented in the registry.

In the example embodiment illustrated in FIG. 1, the client devices 102A-N and the central server 100 interacts with the merchant device(s) 106A-N through the network 104. The client devices 102A-N includes the registry modules 108A-N. The central server 100 includes the registry module 110. In one embodiment, the registry modules 108A-N may be downloaded by the client devices 102A-N from the central server 100. An item boundary may be determined by surrounding a current location of a pointer (e.g., the pointer indicator 1002 of FIG. 10) based on a merchant site (e.g., the merchant site 1000 of FIG. 10) of the merchant devices 106A-N mapping table and a markup language characteristic of the merchant site 1000. The item information may be extracted from within the item boundary.

The item information may be communicated to the registry of the central database 208. In addition, no modification may be required to the merchant site 1000. The registry modules 108A-N may be client-side applications that work across different ones of the merchant site 1000. The set of items being marketed to consumers may be offered by ecommerce portals of the merchant devices 106A-N through the network 104. The client devices 102A-N may include having the registry modules 108A-N to place certain ones of the set of items in the registry associated with the user (e.g., of the client devices 102A-N).

FIG. 2 is an exploded view of the central server 100, according to one embodiment. Particularly, FIG. 2 illustrates the registry module 110, an optimization module 202, a presentation module 204, a consideration pooling module 206, a central database 208, a rules module 210, an error correction module 212, an area locator module 214 an advertising module 216, and a commission module 218 according to one embodiment.

The optimization module 202 may provide optimization by indexing, managing, maintaining and/or simplifying product selection for the users having the registry. The presentation module 204 may enable grouping and/or sorting of items in the registry for the user to access any item information of the registry module 110. The consideration pooling module 206 may enable patron users to pool consideration contributed by them towards the gift for the receiver user who owns the registry.

For example, the patron users can collectively contribute money towards a particular purchase. Alternatively, the patron users can setup a private cash pools and/or can simply contribute towards the registry of the receiver user in general, so that the receiver user can apply that contribution to any gift. The central database 208 may store the details data associated with the items defined through item information uploaded in the registry which was captured through the client devices 102A-N. The rules module 210 may apply a set of algorithms to optimize performance of the registry module 110 and may periodically provide updates to the registry module 110 such that the periodic updates refresh the item information of the registry module 110. The area locator module 214 may capture an area adjacent to a pointer associated with the user in the client devices 102A-N, and may automatically determine the item information associated each item in the registry. The advertising module 216 may inform merchants products modified (e.g., added, deleted, changed) in the registry (e.g., of the registry module 110) and/or donation levels of patrons providing funds to items (e.g., products, services, etc.) in the registry. The commission module 218 may automatically convert incoming an item link (e.g., a link to an item of a webpage) to a commissionable link offered by a merchant affiliate program (e.g., a program which provides incentives to referrer websites).

In the example embodiment illustrated in FIG. 2, the central server 100 includes the registry module 110, the optimization module 202, the presentation module 204, the consideration pooling module 206, the central database 208, the rules module 210 the error correction module 212, area locator module 214, the advertising module 216, and the commission module 218 communicating with each other. In one embodiment, a manual update data generated through a separate window may be applied having extracted item information (e.g., a popup window in which the user corrects data). The manual update data may be communicated to the registry of the central database 208. A coupon module may be referenced having a coupon data with the extracted item information and the manual update data. For example, coupon (e.g., a newsletter, a flier, a marketing brochure, ticket, document, etc.) may be placed in an area adjacent to the item information in the registry.

The merchant site 1000 mapping table may be periodically updated to deliver more relevant results by heuristically adapting the item boundary of a specific merchant site 1000 by observing an error log and manual override patterns of the user of the registry modules 108A-N. A time marker (e.g., a reference signal often repeated periodically, enabling the correlation of specific events with a time scale) may be applied to the item information in the registry such that the time marker indicates how long the item associated with the item information adheres to a set of terms associated with the item. In addition, the registry modules 108A-N may be embedded as an indicator (e.g., a pointer, needle, gauge, dial, meter, etc.) in a browser (e.g., as illustrated in FIG. 10). The item information may be extracted when the user drags and drops the pointer (e.g., the pointer indicator 1002 of FIG. 10) to the indicator.

The registry modules 108A-N may be embedded in a widget (e.g., a Facebook® application) hat can be placed across social media environments. The central server (e.g., the central server 100 of FIG. 1) having the central database 208 may store data captured by the client devices 102A-N through the registry modules 108A-N, and may optimize accuracy of capture of the registry modules 108A-N by monitoring behaviors of the user rectifying (e.g., by manually editing) issues in individual ones of the set of items represented in the registry.

The set of algorithms may be applied by the error correction module 212 of the central server 100 to optimize performance of the registry modules 108A-N and may periodically provide updates to the registry modules 108A-N such that the periodic updates refresh the item information of the registry modules 108A-N. An area adjacent to the pointer indicator 1002 may be captured by the area locator module 214 associated with the user in each of the client devices 102A-N, and may automatically determine the item information associated each item in the registry.

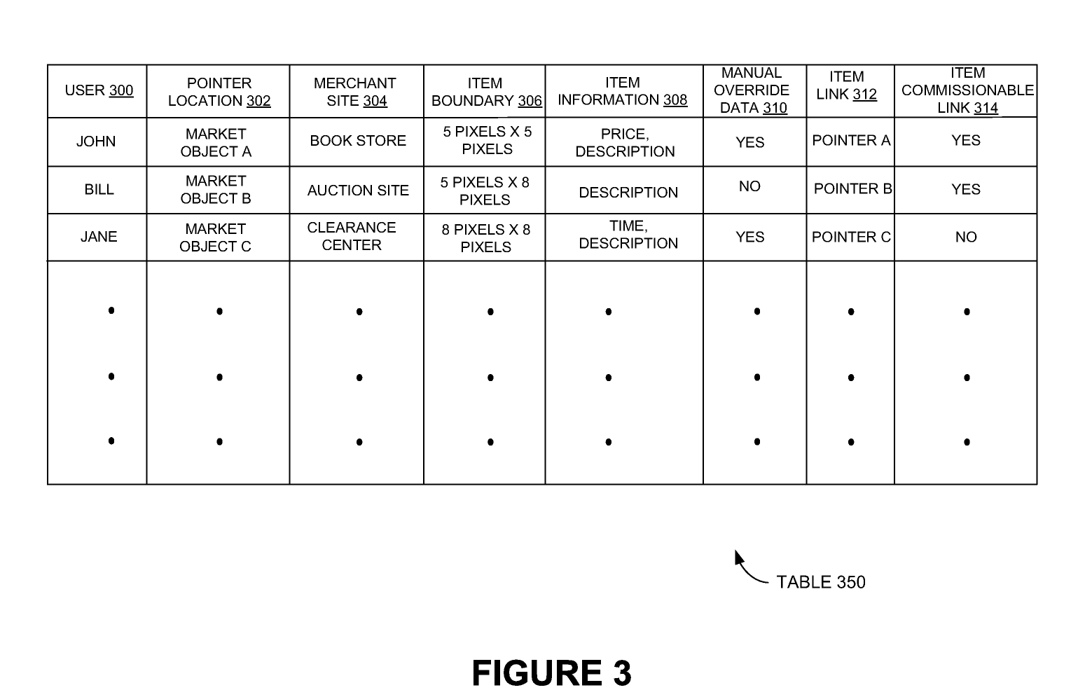

FIG. 3 is a table view of details of item information associated with the registry of the user, according to one embodiment. Particularly, FIG. 3 illustrates a user field 300, a pointer location field 302, a merchant site field 304, an item boundary field 306, an item information field 308, a manual override data field 310 and an item link field 312 and an item commissionable link field 314, according to one embodiment.

The user field 300 may display the name of the user associated with the item information having a registry. The pointer location field 302 may display an arrow like mouse cursor which indicates an item, product, article, gift, etc. having an item boundary surrounding a current location. The merchant site field 304 may display the name of the commercial trading entity who sells commodities. The item boundary field 306 may display acquired size of the graphical image of the item boundary of the item through pixel size. The item information field 308 may display a price, a description, a picture and an offer period of the specific item. The manual override data field 310 may display whether the merchant site (e.g., the merchant site 1000 of FIG. 10) mapping table delivers more relevant results by periodically updating data or not. The item link field 312 may display a navigation element in a website (e.g., for a link associated with the item defined through the item information) to another section of the same website or a different website (e.g., merchant website). The item commissionable link field 314 may display the generated merchant affiliate link which allows the merchants to track sales leads and generate commissions on all sales of user registry. For example, the merchants may offer merchant affiliate program (e.g., linkshare, commission junction, etc.) which entails encoding item link with special codes so that merchants can track and record sales to provide commissions to a service provider (e.g., GiftWisdom.com) on those sales.

In the example embodiment illustrated in FIG. 3, the user field 300 displays “John” in the first row, “Bill” in the second row and “Jane” in the third row, indicating the name of the user associated with the item information having the registry in the user field column 300. The pointer location field 302 displays “Markup object A” in the first row, “Markup object B” in the second row and “Markup object C” in the third row, indicating the arrow like mouse cursor which indicates the item, product, article, gift, etc. having the item boundary surrounding the current location in the pointer location field column 302.

The merchant site field 304 displays “Book Store” in the first row, “Auction Site” in the second row and “Clearance center” in the third row, indicating the name of the commercial trading center who sells items (e.g., goods, services) in the merchant site field column 304. The item boundary field 306 displays “5 pixels*5 pixels” in the first row, “5 pixels*8 pixels” in the second row and “8 pixels*8 pixels” in the third row, indicating acquired size of the graphical image of the item boundary of the item through pixel size in the item boundary field column 306.

The item information field 308 displays “Price, Description” in the first row, “Description” in the second row and “Time, Description” in the third row, indicating a price, a description, a picture and an offer period of the specific item in the item information field column 308. The manual override data field 310 displays “Yes” in the first row, “No” in the second row and “Yes” in the third row indicating whether the merchant site 1000 mapping table delivers more relevant results by periodically updating data or not in the manual override data field column 310. The item link field 312 displays “Pointer A” in the first row, “Pointer B” in the second row and “Pointer C” in the third row, indicating the item the pointer is linked in the item link field column 312.

The item commissionable link field 314 displays “Y” in the first row, “Y” in the second row and “N” in the third row, indicating the whether the merchant affiliate link is generated or not in the item commissionable link column 314.

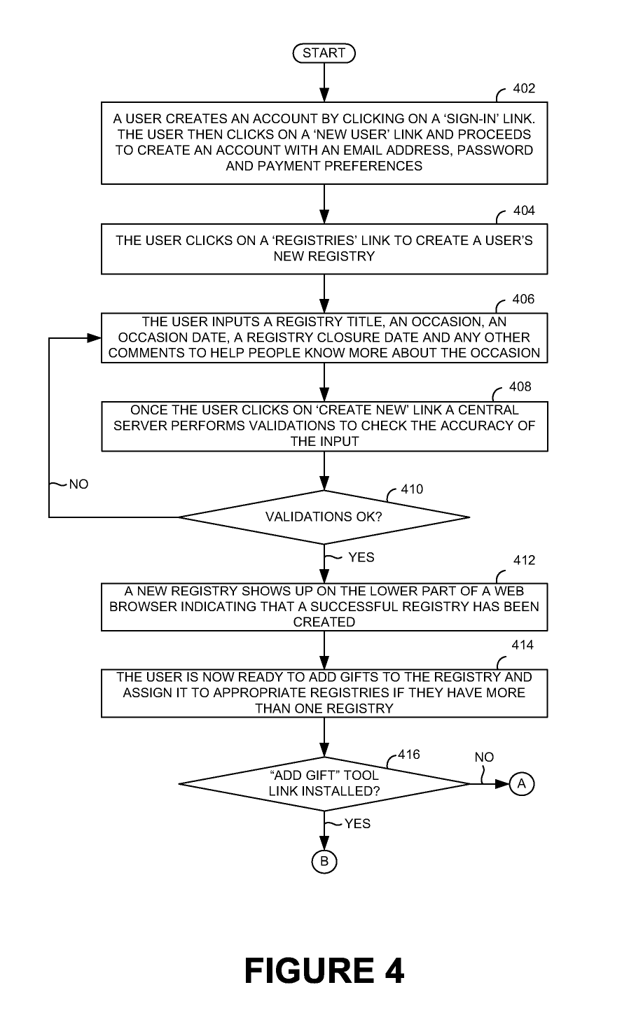

FIG. 4 is a flow chart of installing an “add gift” tool link in the browser by process of creating an account and setting up the registry in a third party ecommerce site, according to one embodiment. In operation 402, an account may be created by a user by clicking on a “sign-in” link. A “new user” link may be clicked by the user to proceed to create an account with an email address, password and payment preferences. In operation 404, a “registries” link may be clicked by the user to create the user's new registry. In operation 406, a registry title, an occasion, a registry closure date and/or any other comments may be uploaded by the user (e.g., using the registry module 110 of FIG. 1) to help people know more about the occasion. In operation 408, validations are performed once the user clicks on “create new” link by the central server 100 to check the accuracy (e.g., using the error correction module 212 of FIG. 2) of the input.

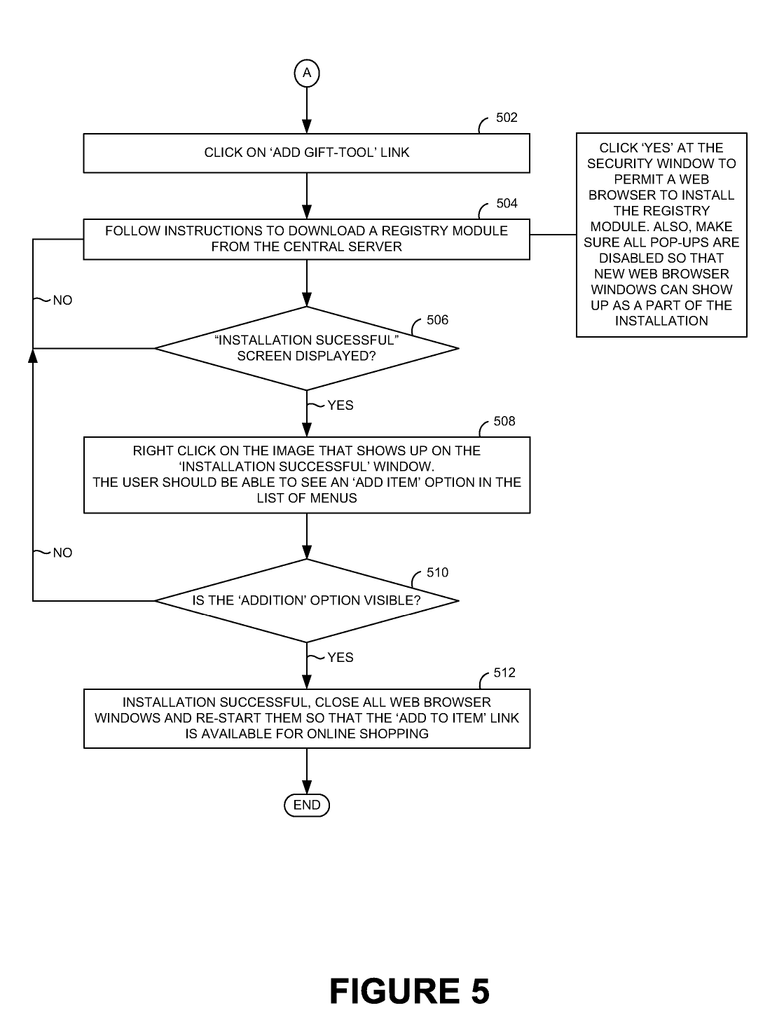

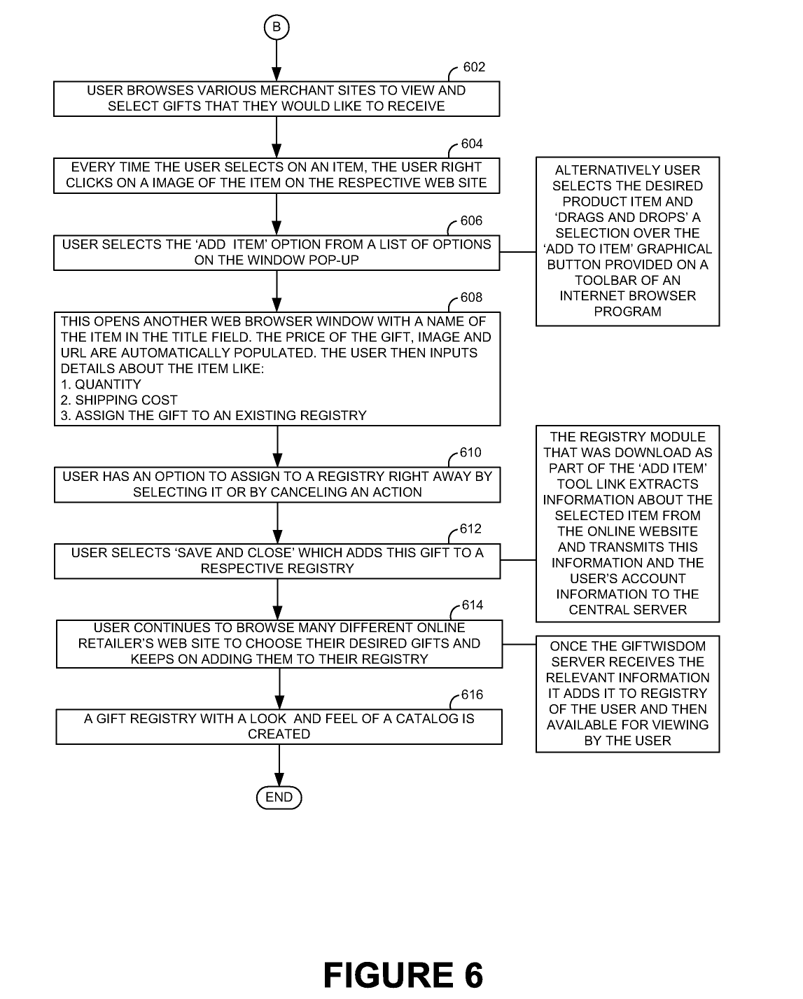

In operation 410, validations to check the accuracy of the input are determined. In operation 412, creation of successful registry may be indicated when the new registry shows up (e.g., using the presentation module 204 of FIG. 2) on the lower part of a web browser. In operation 414, the user may add gifts to the registry and assign item to appropriate registries if they have more than one registry. In operation 416, it may be determined whether “add gift” tool link is installed in the browser or not. If the “add gift” tool link may be installed, operation 602 of FIG. 6 is performed. If the “add gift” tool link is not installed, operation 502 of FIG. 5 is performed.

FIG. 5 is a continuation of the flow chart of FIG. 4 illustrating additional processes when the “add gift” tool link is not installed, according to one embodiment. In operation 502, “add gift-tool” link may be clicked by the user. In operation 504, instructions are followed to download the registry modules 108A-N from the central server 100. The user has to click “yes” at the security window to permit the web browser to install the registry modules 108A-N. The user may also have to make sure all pop-ups are disabled so that new web browser can show up as a part of the installation.

In operation 506, it may be determined whether the “installation successful” screen is displayed or not. If it is displayed, then operation 508 is continued. If it is not, displayed then operation 504 is initiated. In operation 508, the user may right click on the image that shows up on the “installation successful” window. The user may be able to see an “add item” option (e.g., using the presentation module 204 of FIG. 2) in the list of menus. In operation 510, it may be determined whether “addition option” is visible in list of menus or not. If “addition option” may be visible, then operation 512 is initiated. If “addition option” is not visible, then operation 504 is initiated. In operation 512, on successful installation all the web browser windows may be closed and the computer may be restarted so that the “add to item” link is available for online shopping.

FIG. 6 is a continuation of the flow chart of FIG. 4 illustrating additional processes for creating a gift registry, according to one embodiment. In operation 602, the merchant sites (e.g., the merchant site 1000 of FIG. 10) are browsed by the user to view and select gifts that they would like to receive. In operation 604, every time the item may be selected by the user, the image of the item may be right clicked by the user on the respective website.

In operation 606, “add to item” (e.g., the add to item 1004B of FIG. 10) option may be selected by the user from a list of options on the window pop-up. Alternatively the desired product item may be selected by the user. The user may “drag and drop” that selection over the “add to item” 1004 graphical button provided on a toolbar of an internet browser program. In operation 608, another web browser window having automatically populated name of the item in the title field, the price of the gift, image and/or URL may be opened. The details may then input by the user about the item like quantity, shipping cost, assigns the gift to an existing registry, etc. In operation 610, the user may have an option to assign to a registry right away by selecting it. Alternatively, the user may cancel an action. In operation 612, “save and close” may be selected by the user which adds this gift to a respective registry.

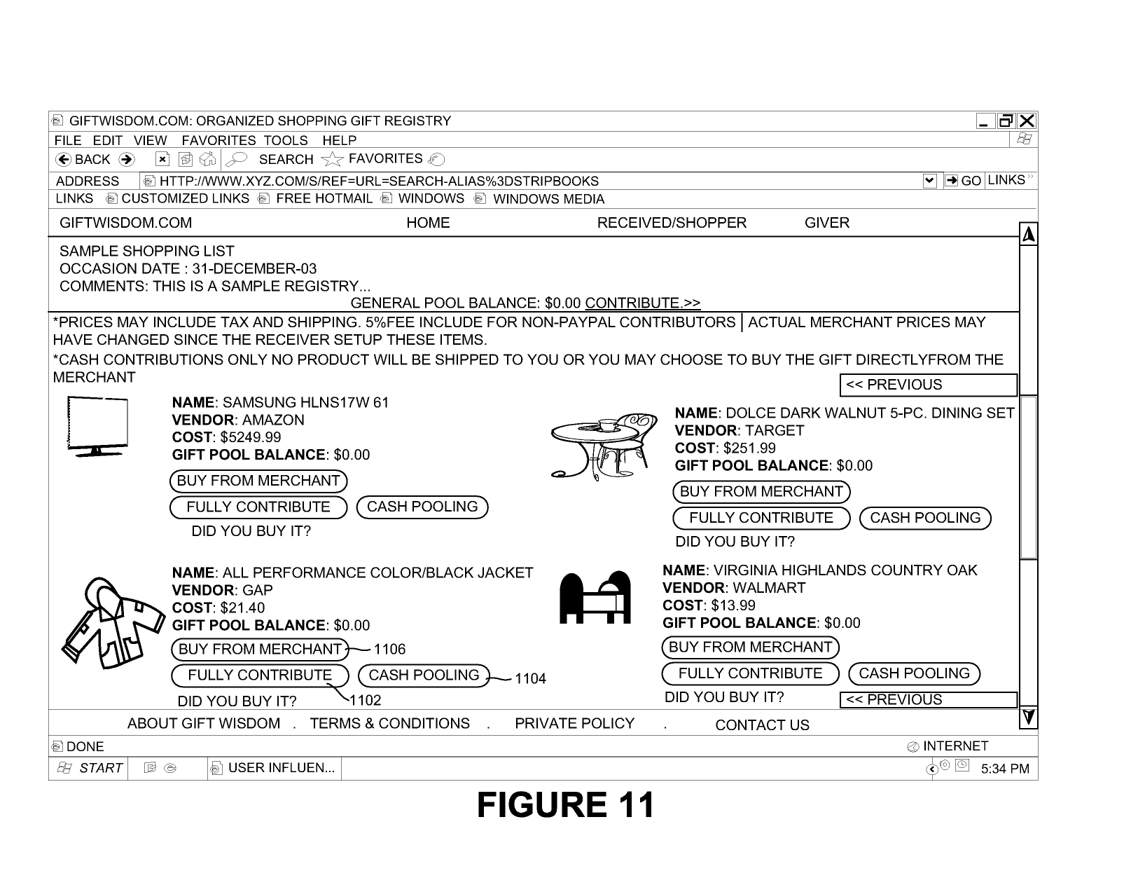

The registry modules 108A-N that was download as part of the “add item” tool link extracts information about the selected item from the online website and transmits this information and the user's account information to the central server 100. In operation 614, browsing many different online retailers' web site may be continued by the user. The user may choose their desired gifts and may keep on adding them to their registry. In operation 616, the gift registry with a look and feel of a catalog may be created (e.g., as illustrated in FIG. 11).

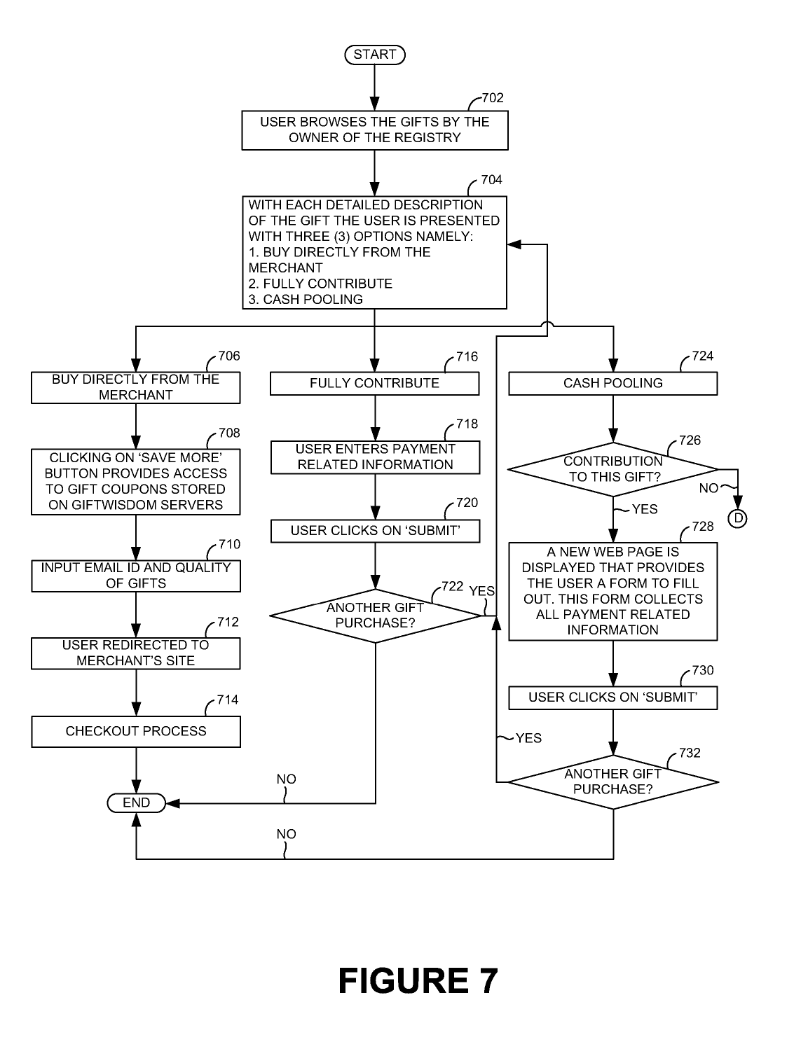

FIG. 7 is a flow chart for contributing gifts through various features, according to one embodiment. In operation 702, the gifts are browsed by the user by the owner of the registry. In operation 704, each detailed description of the gift the user may be presented with three options namely buy directly from the merchant, fully contribute and/or cash pooling.

In operation 706, buying may be directly from the merchant by the user. For example, the user may choose to buy the gift directly from the merchant instead of cash. In operation 708, access to gift coupons stored on giftwisdom servers may be provided by clicking on “save more” button. In operation 710, email id and quality of gifts are input by the user. In operation 712, user redirected to merchant's site (e.g., the merchant site 1000 of FIG. 10). In operation 714, checkout process may be initiated. In operation 716, contribution may be fully made by the user to buy the gift. For example, the user may contribute completely towards a specific gift for the receiver. The contribution may be made using Master card, Visa card, and/or Pay pal account.

In operation 718, payment related information may be entered by user. In operation 720, “submit button” may be clicked by the user. In operation 722, a condition may be determined to check whether user wants to purchase another gift. If user wants to purchase another gift, the operation 704 is initiated or if user does not want to purchase another gift, the process is terminated. In operation 724, for the item which may be captured and stored in the registry, cash pooling is done. For example, cash pools allow the users (e.g., guests, contributors, family friends, co-workers etc.) to collectively contribute money towards a particular purchase. Alternatively the patron users can simply contribute towards the registry of the receiver in general, so that the receiver can apply that contribution to any gift.

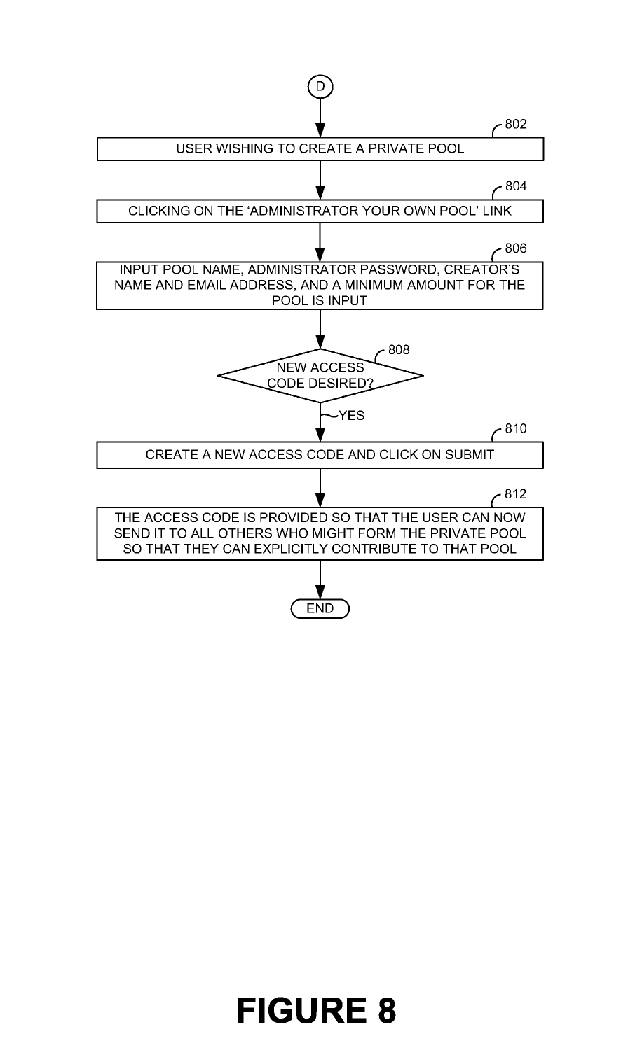

In operation 726, a condition may be determined to check whether user wants to contribute to that gift. If the user is not willing to contribute then operations corresponding to FIG. 8 is initiated. If the user is willing to contribute, operation 728 is initiated. In operation 728, a new web page may be displayed that provides the user a form to fill out. All payment related information may be collected by this form. In operation 730, “submit” may be clicked by the user. In operation 732, a condition may be determined to check whether user wants to purchase another gift. If the user wants to purchase then operation 704 is initiated. If the user does not want to purchase any other gift then process is terminated.

FIG. 8 is a continuation of the flow chart of FIG. 7 illustrating additional processes of creating private cash pools, according to one embodiment. In operation 802, the user may wish to create a private pool. In operation 804, “administer your own pool” link may be clicked by the user to create the private pool. In operation 806, pool name, administrator password, creator's name and email address, and a minimum amount for the pool may be input by the user.

In operation 808, a condition may be determined for desire of new access code. If there is the desire for new access code, then operation 810 is processed. In operation 810, a new access code may be created and “submit” is clicked. In operation 812, the access code may be provided so that the user can now send it to all others who might form the private pool so that they can explicitly contribute to that pool.

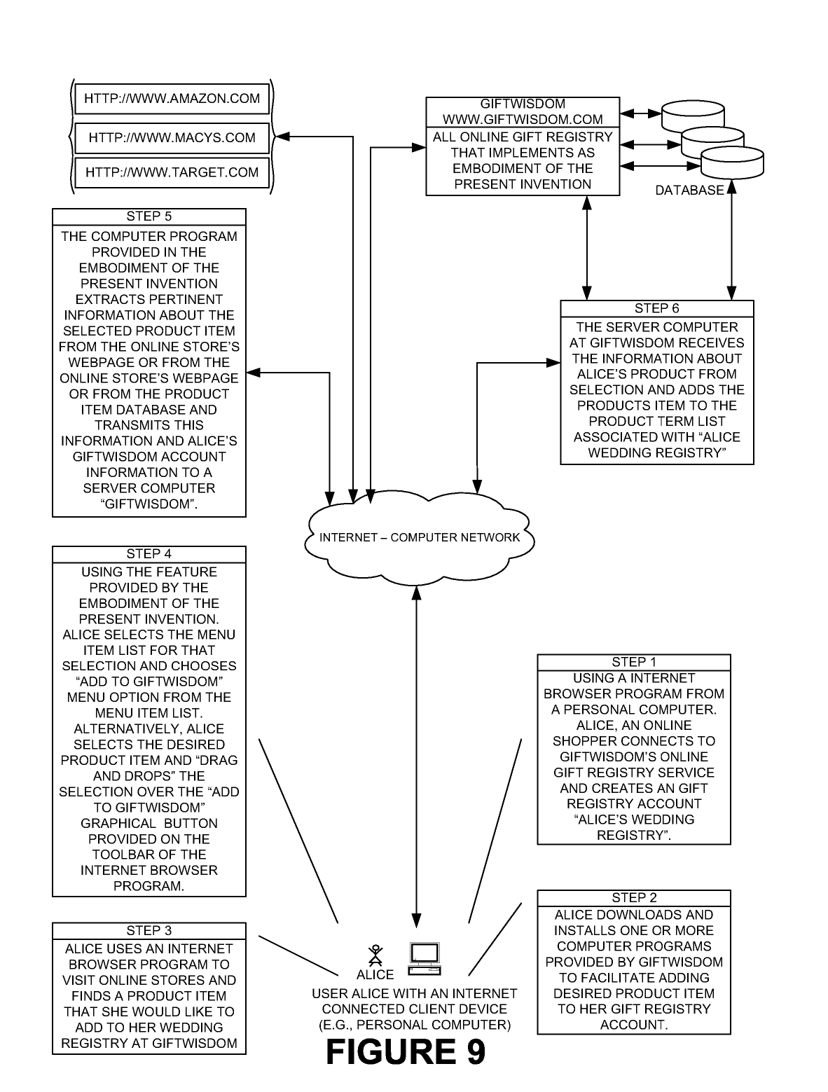

FIG. 9 is a procedure view of giving and receiving gifts through an online shopping process, according to one embodiment. FIG. 9 illustrates the procedure where the receiver (e.g., Alice) having an internet connected client device (e.g., personal computer) may connect to the online shopping process (e.g., Giftwisdom's online gift registry service) and may create a gift registry account (e.g., Alice's wedding registry).

The receiver may now download and install one or more computer programs provided by an online shopping process to facilitate adding a desired product item to a registry account. The receiver may use an internet browser program to visit online stores and find a product item that he/she wishes to add to the gift registry account. The receiver may select the menu item list for the selection and may choose “add to giftwisdom” menu option from the menu option list. In addition, the receiver may select the desired product item and “drag and drop” the selection over the “add to giftwisdom” graphical button provided on the toolbar of the internet browser program.

The computer program may extract information about the selected product item from the online store's webpage and/or from the product item database. The system may transmit this information and the gift registry account information to a server computer. The server computer may receive the information about receiver's item from selection and may add the item to the item term list associated with the gift registry account.

FIG. 10 is a user interface view of a merchant site 1000, according to one embodiment. Particularly, FIG. 10 illustrates a pointer indicator 1002, an indicator 1004A, an indicator 1004B, an indicator 1006, an indicator 1008, an indicator 1010 and an indicator 1012, according to one embodiment.

The pointer indicator 1002 may display an arrow like mouse cursor pointing to the item surrounded by the item boundary. The indicator 1004A may display the location of the pointer indicator 1002 from where the user can select the menu list for that selection and chooses “add item” menu option from the menu item list. The indicator 1004B may display the location of the pointer indicator 1002 from where the user can select the desired product item and “drag and drop” the selection over the graphical button provided on the toolbar of the internet browser. The indicator 1006 may display the price of the item associated with the item information.

The indicator 1008 may display the description of the item associated with the item information. The indicator 1010 may display the limited time during which offer will be open for that particular item. The indicator 1012 may display the other details about the particular product. For example, the details may feature best deals, free upgrades, discounts, warranty period, festival offers, etc.

In the example embodiment illustrated in FIG. 10, the user interface view may display the merchant site 1000 to the receiver (e.g., Bill). The user interface view may have various products featured on the website with best deals which motivates the receiver to search for best price for the gift he/she wishes to setup the registry with products from those merchants.

In one embodiment, a link to details data may be determined associated with the item. The link to details data may be defined through the item information which is adjacent to the pointer indicator 1002 in an area defined by the item boundary. The details data may be automatically extracted from the link. The details data and the item information may be communicated to the registry of the central database 208. A bookmark of a page may be created associated with the link. The bookmark may be associated with the registry such that the details data is accessible through the bookmark embedded in the registry. A donation may be processed provided by the patron of the user associated with the item information.

The donation may be applied toward consideration required to transact the item associated with the item information. The user may redeem the donation (e.g., the cash donation) when the cash donation does not meet the consideration required to transact the item associated with the item information. The central server 100 may be accessed to determine a set of boundaries associated with an area adjacent to pointer indicator 1002 on an external ecommerce page (e.g., as illustrated in FIG. 10). A set of product information may be captured from the determined set of boundaries.

FIG. 11 is a user interface view of a sample registry, according to one embodiment. Particularly, FIG. 11 illustrates a fully contribute option 1102, a cash pooling option 1104 and a buy from merchant option 1106, according to one embodiment.

The fully contribute option 1102 may enable the users to contribute completely towards a specific gift for the receiver. For example, the users may be group of friends, co-workers, family members, patrons, fans, etc. who want to contribute collectively towards the gift for the receiver who owns the registry. In addition, the receiver can view the contributions made to his/her registry. The cash pooling option 1104 may also enable the users to contribute cash collectively towards the specific gift for the receiver. The buy from merchant option 1106 may enable the users who may choose to buy the specific gift directly from the merchant. In addition, the users may have to indicate that they bought gift by marking “Yes” in the registry (e.g., “Did you buy it?” link as illustrated in FIG. 10).

In the example embodiment illustrated in FIG. 11, the user interface view displays the sample shopping list having a general pool balance where the users can contribute collectively towards the gift for the receiver who owns the shopping list. The shopping list also displays various items (e.g., Samsung HLNS17W61, All performance color/black jacket, dolce dark walnut 5-PC. dinning set, Virginia highlands country oak, etc.) along with the item information such as the name of the item, name of the vendor, cost of the item, gift pool balance for the item, etc selected by the receiver who owns the shopping list. In addition, the shopping list also enables the users to choose the gift to the receiver from various options like “fully contribute link”, “cash pooling link” and “buy from merchant”.

In one embodiment, a price, a description, a picture, and an offer period may be automatically determined through the item information. The captured product information based on the user request may be modified. The captured product information may be placed in the registry (e.g., using the registry module 110 of FIG. 1) of the central server 100. The consideration may be processed toward acquisition of the item associated with the product information provided by a third party to the user through the registry. In addition, the payment may be a partial payment applicable to an aggregate payment required to purchase the item associated with the product information for the user. The set of rules associated with the external web page may be periodically refreshed (e.g., the error correction module 212 of FIG. 2) by observing a behavior pattern of the user in modifying the captured product information in relation to locations of the external ecommerce page. A standard link to the captured product information may be automatically converted (e.g., using the commission module 218 of FIG. 2) to a commissionable link offered by a merchant affiliate program. In addition, a merchant of the merchant affiliate program may be informed when the set of product information is modified in the registry and when the consideration toward acquisition is provided by the third party to the user.

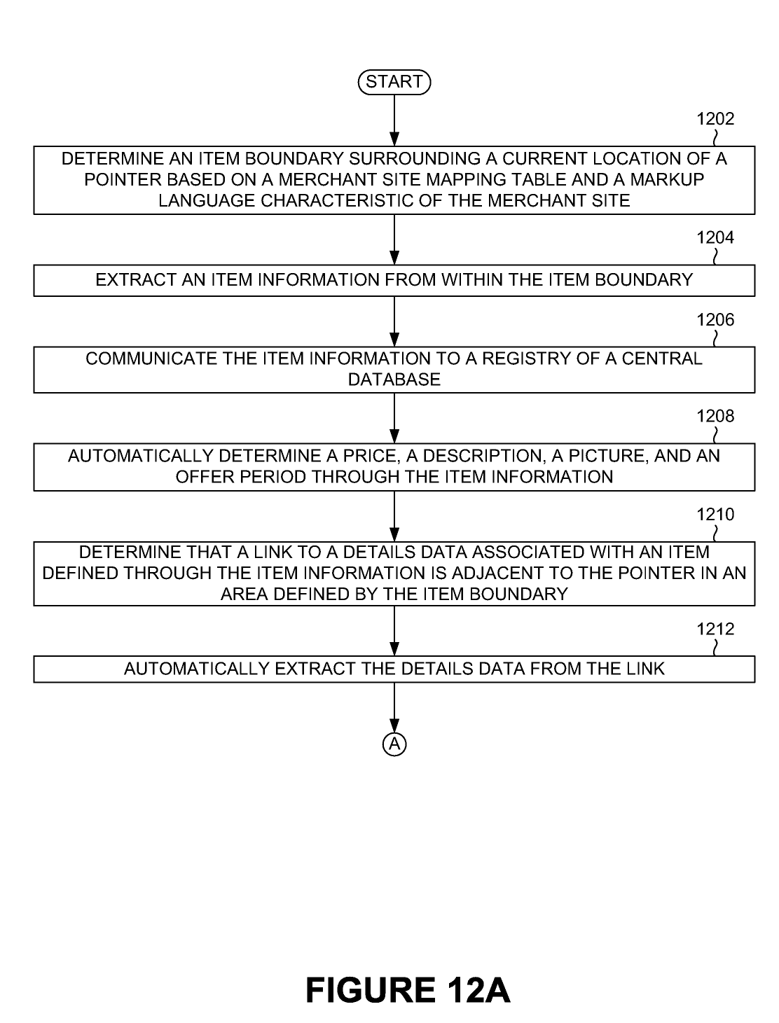

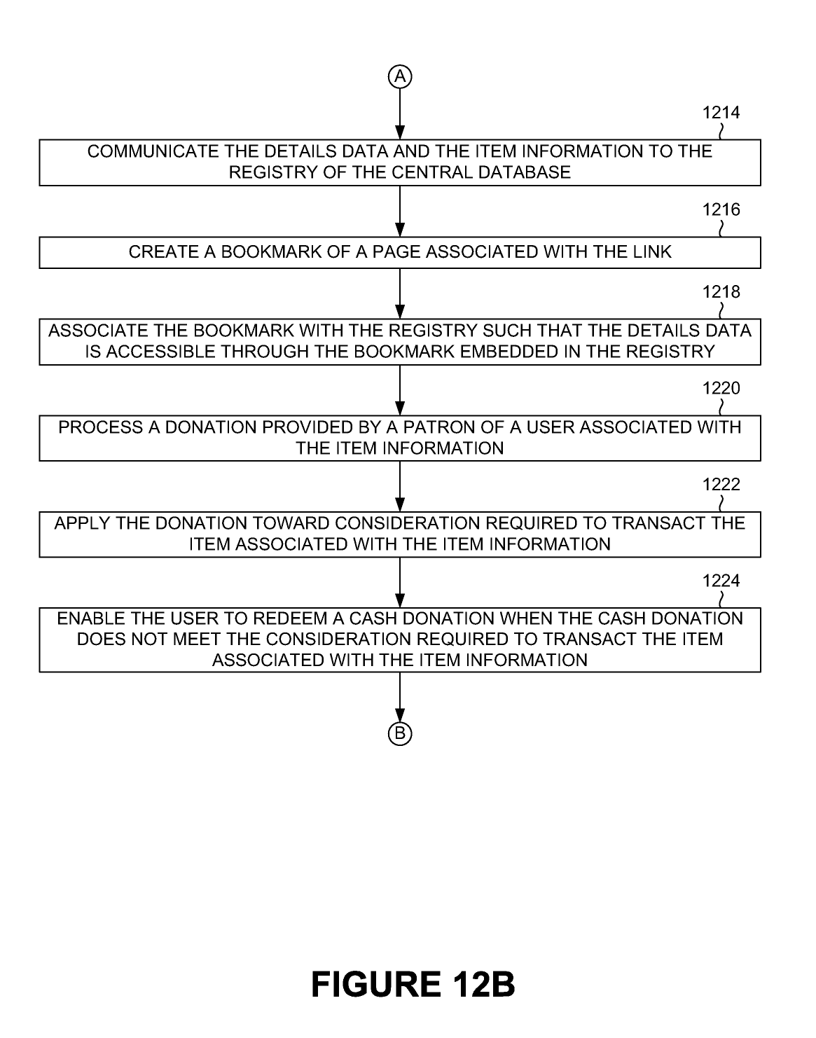

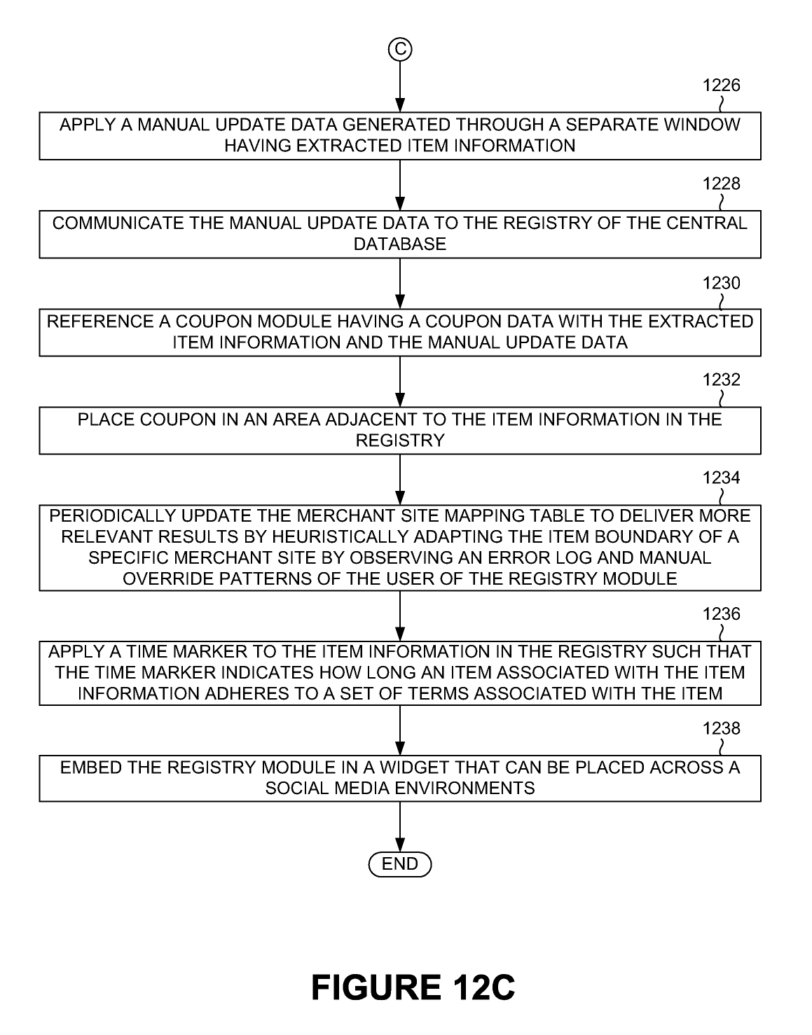

FIG. 12A is a process flow of extracting the details data from the link, according to one embodiment. In operation 1202, an item boundary may be determined surrounding a current location of a pointer (e.g., the pointer indicator 1002 of FIG. 10) based on a merchant site (e.g., the merchant site 1000 of FIG. 10) mapping table and a markup language characteristic of the merchant site 1000. In operation 1204, an item information may be extracted from within the item boundary.

In operation 1206, the item information may be communicated to a registry of a central database (e.g., the central database 208 of FIG. 2). In operation 1208, a price, a description, a picture, and/or an offer period may be determined through the item information. In operation 1210, a link to a details data associated with an item defined through the item information is adjacent to the pointer indicator 1002 may be determined (e.g., using the area locator module 214 of FIG. 2) in an area defined by the item boundary. In operation 1212, the details data may be automatically extracted from the link.

FIG. 12B is a continuation of the process flow of FIG. 12A illustrating additional processes, according to one embodiment. In operation 1214, the details data and the item information may be communicated to the registry of the central database 208. In operation 1216, a bookmark of a page associated with the link may be created. In operation 1218, the bookmark may be associated with the registry such that the details data is accessible through the bookmark embedded in the registry.

In operation 1220, a donation may be processed provided by a patron of a user associated with the item information. In operation 1222, the donation may be applied toward consideration required to transact the item associated with the item information. In operation 1224, the user may be enabled to redeem the cash donation when the cash donation does not meet the consideration required to transact the item associated with the item information.

FIG. 12C is a continuation of the process flow of FIG. 12B illustrating additional processes, according to one embodiment. In operation 1226, a manual update data may be generated through a separate window having extracted item information. In operation 1228, the manual update data may be communicated to the registry of the central database 208. In operation 1230, a coupon module may be referenced having a coupon data with the extracted item information and the manual update data. In operation 1232, coupon may be placed in an area adjacent to the item information in the registry.

In operation 1234, the merchant site 1000 mapping table may be periodically updated (e.g., using the error correction module 212 of FIG. 2) to deliver more relevant results by heuristically adapting the item boundary of a specific merchant site (e.g., the merchant site 1000 of FIG. 10) by observing an error log and manual override patterns of the user of the registry module (e.g., the registry modules 108A-N of FIG. 1). In operation 1236, a time marker may be applied to the item information in the registry such that the time marker indicates how long an item associated with the item information adheres to a set of terms associated with the item. In operation 1238, the registry modules 108A-N may be embedded in a widget that can be placed across any number of social media environments.

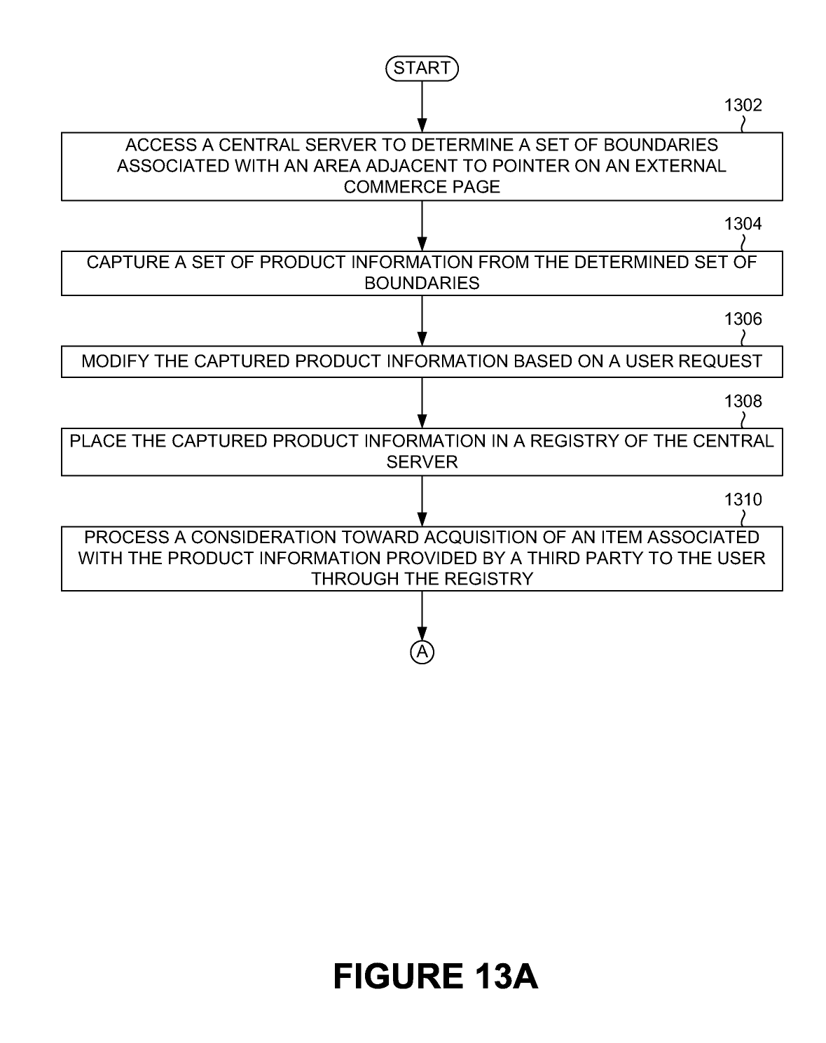

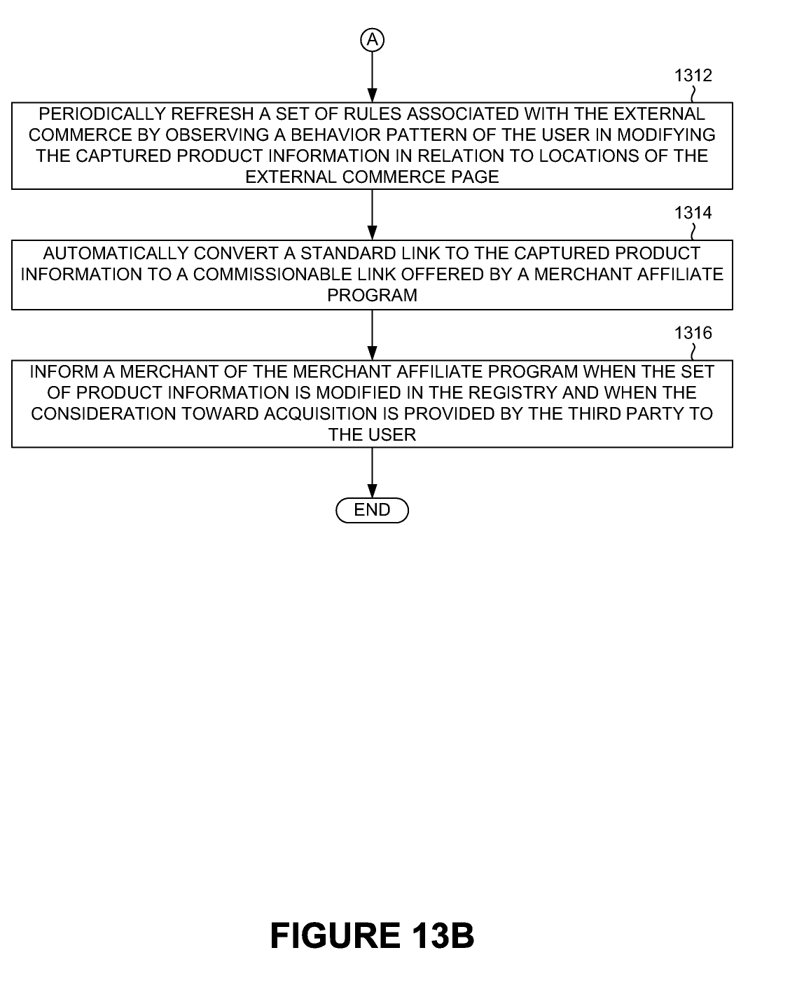

FIG. 13A is a process flow of capturing and placing product information in a registry, according to one embodiment. In operation 1302, a central server (e.g., the central server 100 of FIG. 1) may be accessed to determine a set of boundaries associated with an area adjacent to pointer (e.g., the pointer indicator 1002 of FIG. 10) on an external commerce page (e.g., of the merchant device(s) 106A-N of FIG. 1). In operation 1304, a set of product information may be captured from the determined set of boundaries.

In operation 1306, the captured product information based on a user request may be modified. In operation 1308, the captured product information may be placed in a registry of the central server (e.g., the central server 100 of FIG. 1). In operation 1310, consideration may be processed toward acquisition of an item associated with the product information provided by a third party to the user through the registry

FIG. 13B is a continuation of the process flow of FIG. 13A illustrating additional processes, according to one embodiment. In operation 1312, a set of rules associated with the external commerce page may be periodically refreshed by observing a behavior pattern of the user in modifying the captured product information in relation to locations of the external commerce page. In operation 1314, a standard link to the captured product information may be automatically converted to a commissionable link offered by a merchant affiliate program. Then, in operation 1316, a merchant of the merchant affiliate program may be informed when the set of product information is modified in the registry and when the consideration toward acquisition is provided by the third party to the user.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or in Digital Signal Processor (DSP) circuitry).

For example, the registry modules 108A-N, the registry module 110, the optimization module 202, the presentation module 204, the consideration pooling module 206, the rules module 210, the error correction module 212, the area locator module 214, the advertising module 216, the commission module 218 and/or other modules of FIGS. 1-13B may be enabled using registry circuit, an optimization circuit, a presentation circuit, a consideration pooling circuit, a rules circuit, an error correction circuit, an area locator circuit an advertising circuit, a commission circuit and/or other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order.

The modules in the figures are shown as distinct and communicating with only a few specific module and not others. The modules may be merged with each other, may perform overlapping functions, and may communicate with other modules not shown to be connected in the Figures. Accordingly, the specification and drawings are to be regarded in an illustrative rather than a restrictive sense.

What is claimed is:

1. A method of a registry module, comprising:
determining an item boundary surrounding a current location of a pointer based on at least one of a merchant site mapping table and a markup language characteristic of a merchant site;
extracting an item information from within the item boundary; and
communicating the item information to a registry of a central database.

2. The method of claim 1 wherein no modification is required to the merchant site, and wherein the registry module is a client-side application that works across a plurality of different ones of the merchant site.

3. The method of claim 2 further comprising automatically determining at least one of a price, a description, a picture, and an offer period through the item information.

4. The method of claim 3 further comprising:
determining that a link to a details data associated with an item defined through the item information is adjacent to the pointer in an area defined by the item boundary;
automatically extracting the details data from the link; and
communicating the details data and the item information to the registry of the central database.

5. The method of claim 4 further comprising:
creating a bookmark of a page associated with the link; and
associating the bookmark with the registry such that the details data is accessible through the bookmark embedded in the registry.

6. The method of claim 5 further comprising:
processing a donation provided by a patron of a user associated with the item information; and
applying the donation toward consideration required to transact the item associated with the item information.

7. The method of claim 6 further comprising enabling the user to redeem a cash donation when the cash donation does not meet the consideration required to transact the item associated with the item information.

8. The method of claim 1 further comprising
applying a manual update data generated through a separate window having extracted item information; and
communicating the manual update data to the registry of the central database.

9. The method of claim 8 further comprising:
referencing a coupon module having a plurality of coupon data with the extracted item information and the manual update data; and
placing at least one coupon in an area adjacent to the item information in the registry.

10. The method of claim 9 further comprising periodically updating the merchant site mapping table to deliver more relevant results by heuristically adapting the item boundary of a specific merchant site by observing an error log and manual override patterns of at least one user of the registry module.

11. The method of claim 10 further comprising applying a time marker to the item information in the registry such that the time marker indicates how long an item associated with the item information adheres to a set of terms associated with the item.

12. The method of claim 10 wherein the registry module is embedded as an indicator in a browser, and wherein the user activates the extracting of the item information when the user drags and drops the pointer to the indicator.

13. The method of claim 10 further comprising embedding the registry module in a widget that can be placed across a plurality of social media environments.

14. The method of claim 1 in a form of a machine-readable medium embodying a set of instructions that, when executed by a machine, causes the machine to perform the method of claim 1.

15. A system comprising:
a plurality of ecommerce portals each offering a set of items being marketed to consumers through a network;
a plurality of client devices having a registry module to place at least certain ones of the set of items in a registry associated with a user; and
a central server having a central database to store data captured by the plurality of client devices through the registry module, and to optimize accuracy of capture of the registry modules by monitoring behaviors of a user rectifying issues in individual ones of the set of items represented in the registry.

16. The system of claim 15 further comprising an error correction module of the central server to apply a set of algorithms to optimize performance of the registry module and to periodically provide updates to the registry module such that the periodic updates refresh an item information of the registry module.

17. The system of claim 16 further comprising an area locator module to capture an area adjacent to a pointer associated with a user in each of the plurality of client devices, and to automatically determine the item information associated each item in the registry.

18. A method comprising:
accessing a central server to determine a set of boundaries associated with an area adjacent to pointer on an external commerce page;
capturing a set of product information from the determined set of boundaries; and
modifying the captured product information based on a user request;
placing the captured product information in a registry of the central server; and
processing a consideration toward acquisition of an item associated with the product information provided by a third party to the user through the registry.

19. The method of claim 18 wherein a payment is a partial payment applicable to an aggregate payment required to purchase an item associated with the product information for the user.

20. The method of claim 19 further comprising:
periodically refreshing a set of rules associated with the external commerce page by observing a behavior pattern of the user in modifying the captured product information in relation to locations of the external ecommerce page; and
automatically converting a standard link to the captured product information to a commissionable link offered by a merchant affiliate program; and
informing a merchant of the merchant affiliate program when the set of product information is modified in the registry and when the consideration toward acquisition is provided by the third party to the user.
